(19) United States
(12) Patent Application Publication
(10) Pub. No.: US 2009/0223789 A1
(43) Pub. Date: Sep. 10, 2009

(54) STEERING WHEEL WITH INTEGRATED FUNCTION SWITCHES

(76) Inventor: CLAUDIO R. BALLARD, HUNTINGTON, NY (US)

Correspondence Address: HOWISON & ARNOTT, L.L.P, P.O. BOX 741715, DALLAS, TX, 75374-1715, US

(21) Appl. No.: 12/395,688

(22) Filed: Mar. 1, 2009

Related U.S. Application Data
(60) Provisional application No. 61/034,627, filed on Mar. 7, 2008.

(51) Int. Cl. H01H 9/00

(52) U.S. Cl. 200/61.54

(57) ABSTRACT

A vehicle steering wheel having integrated function switches for controlling the vehicle's head lights, turn signals and cruise control includes a generally circular wheel member; a central hub, left and a right spoke members extending between the central hub and the generally circular wheel member, the spoke members being angled away from a plane defined by the wheel member and left and a right four-way rocker type switches mounted in the left and right spoke members adjacent outer ends adjacent the generally circular wheel member, the left rocker switch comprising a headlight high-beam/low-beam selector and turn signal selector and the right rocker switch comprising an actuate and set selector of the vehicle's cruise control system.

### CROSS-REFERENCE TO RELATED APPLICATIONS

This application claims the benefit of U.S. Provisional Application for Patent Ser. No. 61/034,627, filed Mar. 7, 2008, and entitled STEERING WHEEL WITH INTEGRATED FUNCTION SWITCHES, the specification of which is incorporated herein in its entirety by reference.

### TECHNICAL FIELD

The following disclosure relates to a steering wheel with integrated function switches.

### BACKGROUND

Operation of a typical automobile or truck requires controlling numerous devices and functions. These devices and functions include turn signals, cruise control, windshield wipers, headlights, and high and low beam selection. Typically, such devices and functions are controlled by means of switches connected to or incorporated in “stalk” type devices mounted on the steering column of the vehicle. In many instances, such switches control numerous functions. For example the same “stalk” type actuator configured for high and low headlight beam control by moving the stalk back and forth and controlling a cruise control function by twisting a rotatable portion of the stalk.

However, stalk type switches and actuators and switches can be a source of confusion for a vehicle operator that is not familiar with the operational details of the particular switch. The vehicle operator must also steer the vehicle with one hand while manipulating this type of switch. Further, in small vehicles, such as two seat roadster type automobiles, such switches can be a hindrance to an operator entering and exiting the vehicle. Stalk type switches may also be aesthetically unappealing to consumers that prefer simplicity in vehicle controls. Consequently, there exists a need for simple, convenient switches for controlling vehicle functions and devices such as turn signals and cruise control.

### SUMMARY

In one aspect thereof, a vehicle steering wheel having integrated function switches is disclosed. The steering wheel includes a generally circular wheel member, a central hub with at least two spoke members extending between the central hub and the generally circular wheel member. The spoke members are angled away from a plane defined by the wheel member. The steering wheel has four-way rocker type switches mounted in at least two spoke members adjacent the outer end of the spoke members and adjacent the generally circular wheel member. The first rocker switch is configured to actuate the vehicle's turn signals when toggled in a direction generally parallel to the spoke and to actuate the vehicle's headlight high-beam selector when toggled in a direction generally perpendicular to the spoke. The second rocker switch is configured to actuate and set acceleration of the vehicle's cruise control system when toggled in a direction generally perpendicular to the spoke member and to activate the coast and resume functions of the vehicle's cruise control system when toggled in a direction generally parallel to the spoke member.

In another aspect, a vehicle steering wheel having integrated function switches for controlling the vehicle's headlights, turn signals and cruise control, includes a generally circular wheel member having a central hub. Left and a right spoke members extend between the central hub and the generally circular wheel member. In one embodiment, the spoke members are angled away from a plane defined by the wheel member at an angle of between about twenty five and thirty five degrees. In another variation the left and a right spoke members are angled away from a plane parallel to the wheel member at an angle of about thirty degrees. Left and right four-way rocker type switches are mounted in the left and right spoke members adjacent outer ends adjacent the generally circular wheel member. The left and right rocker switches may be self-centering and have four legs for actuating various devices. For example, the left rocker switch may comprise a headlight high-beam/low-beam selector and turn signal selector while the right rocker switch includes an actuate and set selector of the vehicle's cruise control system.

In one variation, the left rocker switch is configured to actuate the vehicle's turn signals when toggled in a direction generally parallel to the spoke member and the vehicle's headlight high-beam/low-beam selector when toggled in a direction generally perpendicular to the spoke member. The right rocker switch may be is configured to actuate and set acceleration of the vehicle's cruise control system when toggled in a direction generally perpendicular to the spoke member and to activate coast and resume function of the vehicle's cruise control system when toggled in a direction generally parallel to the spoke member. The vehicle steering wheel may be provided with a resilient cover and a decorative cover for the central hub.

In yet another aspect, a vehicle includes a steering wheel with integrated function switches for controlling the vehicle's head lights, turn signals and cruise control. The steering wheel includes a generally circular wheel member, a central hub and a plurality of spoke members extending between the central hub and the generally circular wheel member. The spoke members may be angled away from a plane defined by the wheel member. Four-way rocker type switches are mounted in opposed ones of the spoke members near or adjacent outer ends of the spoke members and adjacent the generally circular wheel member. A first one of the rocker switches mounted in a first one of the spokes includes a headlight high-beam/low-beam selector and turn signal selector. A second one of the rocker switches mounted in second one of the spoke members includes an actuate and set selector for the vehicle's cruise control system.

### BRIEF DESCRIPTION OF THE DRAWINGS

For a more complete understanding, reference is now made to the following description taken in conjunction with the accompanying Drawings in which:

FIG. 1 is a front view of a steering wheel according to the present disclosure;

FIG. 2 illustrates a partial side view of the steering wheel of FIG. 1; and

FIGS. 3 and 4 are partial perspective views of a steering wheel according to the present disclosure installed in a vehicle.

### DETAILED DESCRIPTION

Referring now to the drawings, wherein like reference numbers are used herein to designate like elements throughout, the various views and embodiments of a steering wheel with integrated function switches. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

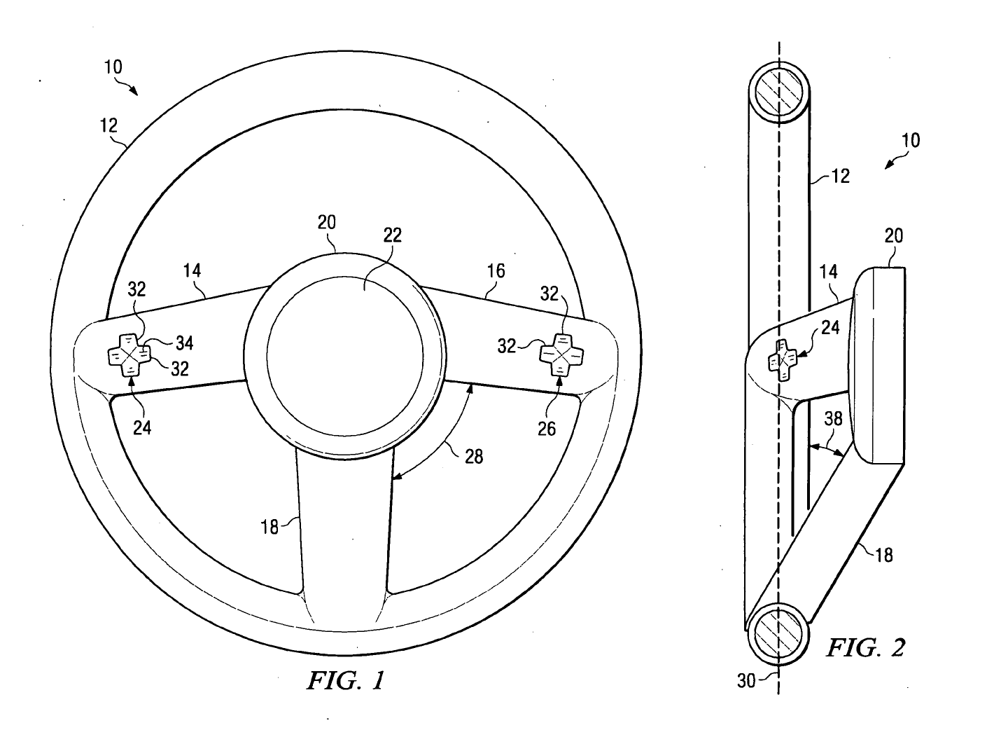

FIG. 1 is a front view of a steering wheel 10 according to the disclosure. Steering wheel 10 includes a generally circular wheel member 12, left and right spoke members 14 and 16 and a lower spoke member 18. In one embodiment the internal angle 28 between left and right spoke members 14 and 16 and lower spoke member 18 is less than ninety degrees. Wheel member 12 may be covered with a resilient material such as an elastomer or leather in order to enhance the feel of the steering wheel 10. Spoke members 14, 16 and 18 extend between wheel member 12 and a central hub 20. In one embodiment, central hub 20 includes a decorative cover 22. A switch for a vehicle horn may be incorporated into steering wheel 10 beneath cover 22.

Left and right spoke members 14 and 16 each incorporate a four way rocker switches 24, 26, respectively. Rocker switches 24 and 26 are formed in the shape of a cross having legs 32 extending at ninety degrees intervals from the center of the rocker switch. In one embodiment, each of legs 32 includes indicia 34 indicating the function controlled or actuated by pressing or toggling the particular leg 32. In one embodiment, switches 24 are self-centering.

In one embodiment, left rocker switch 24 controls the vehicle's headlight high-beam/low-beam selector and turn signals. Toggling or pressing the lower leg 32 of left rocker switch 24 actuates the vehicle's low-beam headlights. Toggling or pressing the upper leg 32 of left rocker switch 24 actuates the vehicle's high beam headlights. Toggling or pressing the left leg 32 of left rocker switch 24 actuates the vehicle's left turn signals. Toggling or pressing the right leg 32 of left rocker switch 24 actuates the vehicle's right turn signals.

Right rocker switch 26 controls the vehicle's cruise control system. Toggling the lower leg 32 of right rocker switch 26 turns the cruise control system on and off. Toggling the upper leg 32 of right rocker switch 26 sets the acceleration. Toggling the right leg of right rocker switch 26 sets the cruise control system to coast. Toggling the left leg of right rocker switch 26 resumes the cruise control operation after the cruise control system has been disengaged, for example, by applying the vehicle's brakes.

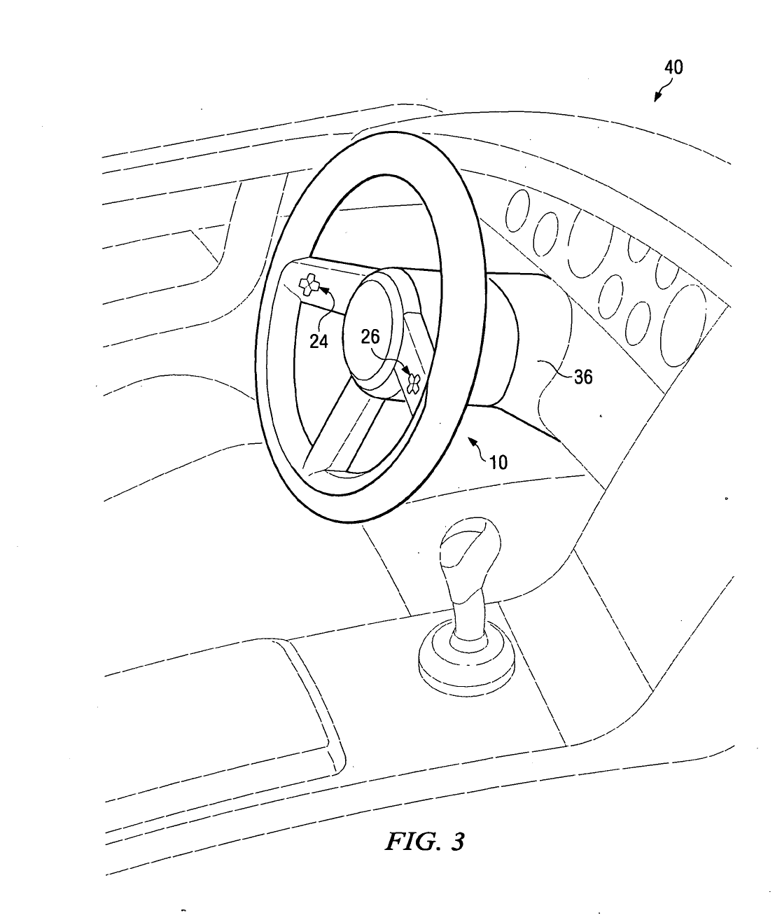

FIG. 2 is a partial side view of steering wheel 10. In one embodiment, spoke members 14, 16 and 18 are angled away from a plane 30 passing through circular wheel member 12. Spoke members 14, 16 and 18 may be angled away from plane 30 at an angle between twenty-five degrees and thirty-five degrees. In the illustrated embodiment, spoke members 14, 16 and 18 are each angled away from plane 30 at an angle 38 of approximately thirty degrees.

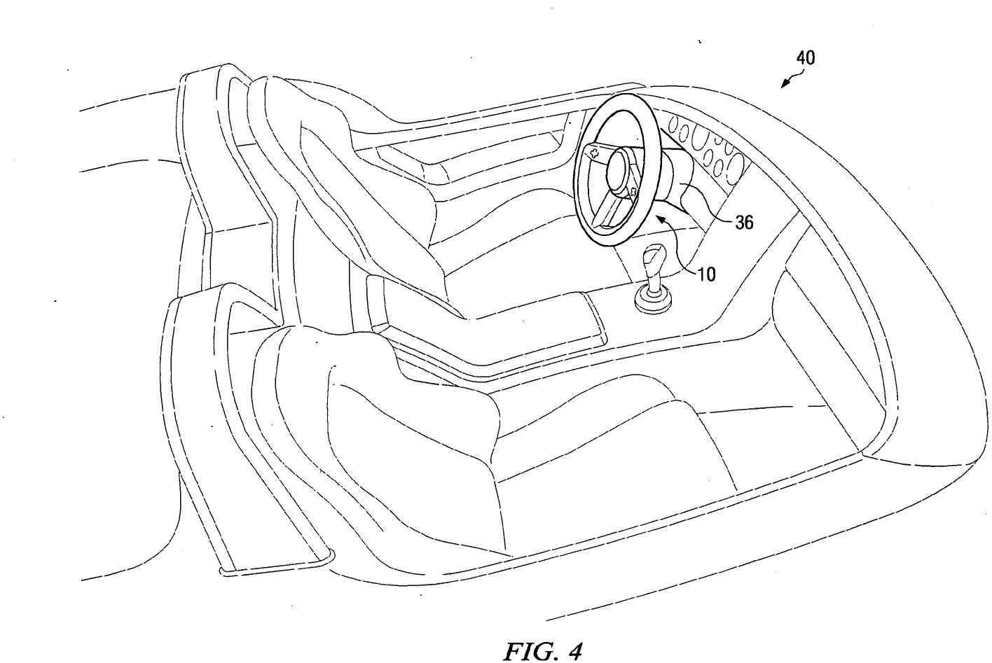

FIGS. 3 and 4 are partial perspective views of steering wheel 10 installed in a two seat, roadster style vehicle 40. In accordance with another embodiment, a steering assembly is provided comprising a steering wheel 10 and a steering column 36 of the roadster type vehicle 40 which does not incorporate the conventional (and unsightly) column-mounted control “stalks” typically used to control turn signals and/or the cruise control system. Thus, incorporating these functions into switches 24 and 26 in steering wheel 10 provides a more aesthetically pleasing appearance to the steering assembly while simultaneously providing easy access to controls for the functions.

It will be appreciated by those skilled in the art having the benefit of this disclosure provides a steering wheel with integrated function switches. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

1. A vehicle steering wheel having integrated function switches comprising:
a generally circular wheel member;
a central hub;
at least two spoke members extending between the central hub and the generally circular wheel member, the spoke members being angled away from a plane defined by the wheel member; and
a four-way rocker type switch mounted in each of the at least two spoke members adjacent outer ends of the spoke members and adjacent the generally circular wheel member wherein a first one of the rocker switches is configured to actuate the vehicle's turn signals when toggled in a direction generally parallel to the spoke member and the vehicle's headlight high-beam/low-beam selector when toggled in a direction generally perpendicular to the spoke member and wherein a second one of the rocker switches is configured to actuate and set acceleration of the vehicle's cruise control system when toggled in a direction generally perpendicular to the spoke member and to activate coast and resume function of the vehicle's cruise control system when toggled in a direction generally parallel to the spoke member.

2. The vehicle steering wheel of claim 1 wherein the four-way rocker switches are self-centering.

3. The vehicle steering wheel of claim 1 wherein the wheel member is provided with a resilient cover.

4. The vehicle steering wheel of claim 1 wherein the central hub includes a decorative cover.

5. The vehicle steering wheel of claim 1 wherein the at least two spoke members are angled away from a plane parallel to the wheel member at an angle of between about twenty five and thirty five degrees.

6. The vehicle steering wheel of claim 1 wherein the at least two spoke members are angled away from a plane parallel to the wheel member at an angle of about thirty degrees.

7. The vehicle steering wheel of claim 1 further comprising a third spoke member extending between the central hub and wheel at a circumferential position between the at least two spoke members and wherein the internal angle between the third spoke member and the at least two spoke members is less than ninety degrees.

8. A vehicle steering wheel having integrated function switches for controlling the vehicle's head lights, turn signals and cruise control, the steering wheel comprising:
a generally circular wheel member;
a central hub;
left and a right spoke members extending between the central hub and the generally circular wheel member, the spoke members being angled away from a plane defined by the wheel member; and
left and a right four-way rocker type switches mounted in the left and right spoke members adjacent outer ends adjacent the generally circular wheel member, the left rocker switch comprising a headlight high-beam/low-beam selector and turn signal selector and the right rocker switch comprising an actuate and set selector of the vehicle's cruise control system.

9. The vehicle steering wheel of claim 8 wherein the left and right rocker switches each include four legs and wherein each of the rocker switches is self-centering.

10. The vehicle steering wheel of claim 9 wherein each of legs includes indicia indicating the function controlled or actuated by toggling the leg.

11. The vehicle steering wheel of claim 8 wherein the left one of the rocker switches is configured to actuate the vehicle's turn signals when toggled in a direction generally parallel to the spoke member and the vehicle's headlight high-beam/low-beam selector when toggled in a direction generally perpendicular to the spoke member.

12. The vehicle steering wheel of claim 8 wherein the right one of the rocker switches is configured to actuate and set acceleration of the vehicle's cruise control system when toggled in a direction generally perpendicular to the spoke member and to activate coast and resume function of the vehicle's cruise control system when toggled in a direction generally parallel to the spoke member.

13. The vehicle steering wheel of claim 8 wherein the wheel member is provided with a resilient cover and wherein the central hub includes a decorative cover.

14. The vehicle steering wheel of claim 8 wherein the left and a right spoke members are angled away from a plane parallel to the wheel member at an angle of between about twenty five and thirty five degrees.

15. The vehicle steering wheel of claim 8 wherein the left and a right spoke members are angled away from a plane parallel to the wheel member at an angle of about thirty degrees.

16. The vehicle steering wheel of claim 15 further comprising a third spoke member extending between the central hub and wheel at a circumferential position between the left and right spoke members and wherein the internal angle between the third spoke member and the left and a right spoke members is less than ninety degrees.

17. The vehicle steering wheel of claim 8 further comprising a switch for a vehicle horn positioned beneath a decorative cover on the central hub.

18. A vehicle having a steering wheel with integrated function switches for controlling the vehicle's head lights, turn signals and cruise control, the steering wheel comprising:
a generally circular wheel member;
a central hub;
a plurality of spoke members extending between the central hub and the generally circular wheel member, the spoke members being angled away from a plane defined by the wheel member; and
four-way rocker type switches mounted in opposed ones of the spoke members adjacent outer ends adjacent the generally circular wheel member, a first one of the rocker switches mounted in a first one of the spokes comprising a headlight high-beam/low-beam selector and turn signal selector and a second one of the rocker switches mounted in second one of the spoke members comprising an actuate and set selector of the vehicle's cruise control system.

19. The vehicle of claim 18 further comprising a third spoke member extending between the central hub and wheel at a circumferential position between the first and second spoke members and wherein the internal angle between the third spoke member and the opposed spoke members is less than ninety degrees.

20. The vehicle of claim 18 wherein the first one of the rocker switches is configured to actuate the vehicle's turn signals when toggled in a direction generally parallel to the first spoke member and the vehicle's headlight high-beam/low-beam selector when toggled in a direction generally perpendicular to the first spoke member and wherein the second one of the rocker switches is configured to actuate and set acceleration of the vehicle's cruise control system when toggled in a direction generally perpendicular to the second spoke member and to activate coast and resume function of the vehicle's cruise control system when toggled in a direction generally parallel to the second spoke member.
